(19) United States
(12) Patent Application Publication
(10) Pub. No.: US 2026/0098539 A1
(43) Pub. Date: Apr. 9, 2026

(54) TOOL AND METHOD FOR DETERMINING IMPELLER LEADING EDGE CONFORMITY

(71) Applicant: PRATT & WHITNEY CANADA CORP., Longueuil (CA)

(72) Inventors: Jeff BEAUDET, Saint-Bruno-de-Montarville (CA); Alain PICARD, Varennes (CA); Louis BRILLON, Varennes (CA); Maxence JOTTRAS, Montréal (CA)

(21) Appl. No.: 18/909,450

(22) Filed: Oct. 8, 2024

(51) Int. Cl. F04D 27/00

(52) U.S. Cl. CPC F04D 27/001; F05D 2220/323; F05D 2260/83

(57) ABSTRACT

A validation tool for determining conformity of leading edges of vanes on an impeller of an aircraft engine includes a support and a probe element. The support has a base and a spindle extending away from the base, the base being configured to be received on a reference surface of the impeller and the spindle defining a spindle axis. The probe element is rotatably mounted on the support and includes an annular body defining a central bore matingly receiving the spindle of the support therein. The probe element is rotatable about the spindle axis and includes a conformal probe thereon extending axially toward the base of the support. The conformal probe is configured to have a clearance fit with multiple of the leading edges at a same span-wise position of each, when the probe element is rotated on the spindle of the support.

### TECHNICAL FIELD

The application relates generally to impellers for centrifugal compressors of aircraft engines, and more particular to erosion measurement of such impellers.

### BACKGROUND

Impellers in centrifugal compressors, such as those used in aircraft engines for example, are subjected to environmental conditions which can cause wear over time. The airfoils or vanes of the impeller are often complex in shape and are particularly susceptible to such wear, which can include erosion of the leading edges of the blades in such impellers. Erosion of the leading edges of impeller blades can negatively impact performance and efficiency of the compressor, and thus that of the aircraft engine.

There is therefore a need to be able to accurately measure leading edge erosion of impeller blade airfoils.

### SUMMARY

There is accordingly provided, a validation tool for determining conformity of leading edges of vanes on an impeller of an aircraft engine, the validation tool comprising: a support including a base and a spindle extending away from the base, the base being configured to be received on a reference surface of the impeller and the spindle defining a spindle axis; and a probe element rotatably mounted on the support, the probe element including an annular body defining a central bore matingly receiving the spindle of the support therein, the probe element being rotatable about the spindle axis and including a conformal probe thereon extending axially toward the base of the support and configured to have a clearance fit with multiple of the leading edges at a same span-wise position of each when the probe element is rotated on the spindle of the support.

In certain embodiments, the validation tool as defined above and described herein includes one or more of the following features, in whole or in part and in any combination.

In certain aspects, the conformal probe is located at a fixed radial position relative to the spindle axis.

In certain aspects, the conformal probe has a probe tip that is shaped and sized to be complimentary to the leading edges of the impeller.

In certain aspects, the probe element includes one or more fingers extending radially outward from the annular body, each of the one or more fingers having the conformal probe thereon.

In certain aspects, the one or more fingers are fixed on the annular body at circumferentially spaced-apart positions thereon.

In certain aspects, the one or more fingers and the conformal probe thereon are integrally formed with the annular body of the probe element.

In certain aspects, the conformal probe on each of the one or more fingers is different.

In certain aspects, the conformal probe has a radial length in a direction radial to the spindle axis that is configured to be less than a full-span length of the leading edge from a hub to a tip of the vanes.

In certain aspects, the conformal probe is positioned to radially straddle a mid-span point of the leading edge between the hub to the tip of the vanes.

In certain aspects, the conformal probe has a radial length in a direction that is radial to the spindle axis that covers more than 50% of a full-span length of the leading edge.

In certain aspects, the conformal probe is configured to extend along at least a radially outer half of the leading edge.

In certain aspects, the radial length of the conformal probe is substantially equal to the full-span length of the leading edge.

In certain aspects, the conformal probe is located only on one circumferential side of the one or more fingers.

In certain aspects, the conformal probe has a circumferential thickness that is smaller than that of the one or more fingers.

In certain aspects, the circumferential thickness of the conformal probe is less than half of the circumferential thickness of the one or more fingers.

In certain aspects, a detection system is operable for determining that the leading edges of the impeller conform to a specification by detecting the presence of the clearance fit between the conformal probe and the leading edges.

There is also provided a method for determining conformity of leading edges of vanes on an impeller of an aircraft engine, the method comprising: abutting a base of a validation tool against a reference surface on a front face of the impeller, the validation tool including a spindle extending outwardly from the base and defining a spindle axis; mounting a probe element of the validation tool on the spindle for rotation about the spindle axis adjacent the leading edges of the vanes of the impeller; rotating the probe element on the spindle about the spindle axis to thereby rotate one or more conformal probes of the probe element past the leading edges of the impeller; and determining that the leading edges of the impeller conform to a specification of the leading edges by detecting the presence of a clearance fit between the one or more conformal probes and the leading edges.

In certain embodiments, the method as defined above and described herein includes one or more of the following features, in whole or in part and in any combination.

In certain aspects, the method includes determining that the leading edges of the impeller are non-conforming with the specification by detecting the presence of an axial gap between the one or more conformal probes and the leading edges when the probe element is rotated on the spindle about the spindle axis.

In certain aspects, each of the one or more conformal probes of the probe element is located at a fixed radial distance away from the spindle axis, the fixed radial distance corresponding to a common span-wise position on each of the leading edges, and using the one or more conformal probes to determine that the common span-wise position on each of the leading edges conforms to the specification.

In certain aspects, the probe element includes multiple of the one or more conformal probes, the method further including using each of the multiple conformal probes to validate a different parameter of the leading edges of the impeller.

### BRIEF DESCRIPTION OF THE DRAWINGS

Reference is now made to the accompanying figures in which:

FIG. 1 is a schematic cross-sectional view of an aircraft engine;

FIG. 2 is an enlarged cross-sectional view of a portion of a centrifugal compressor of the aircraft engine of FIG. 1, taken from region II in FIG. 1, having an impeller and a downstream diffuser;

FIG. 3 is a cross-sectional view of an impeller of the aircraft engine of FIGS. 1-2, having a validation tool mounted thereto for validating conformity of the leading edges of the impeller;

FIG. 4 is a perspective view of the validation tool and impeller of FIG. 3;

FIG. 5 is a disassembled view of the validation tool of FIGS. 3-4;

FIGS. 6A and 6B are partial, detailed views of conformal probes of the validation tool of FIGS. 3-5 validating conformity of the leading edges of the impeller; and

FIG. 7 is a flow-chart depicted a method of validating conformity of leading edges of an impeller in accordance with the present disclosure.

### DETAILED DESCRIPTION

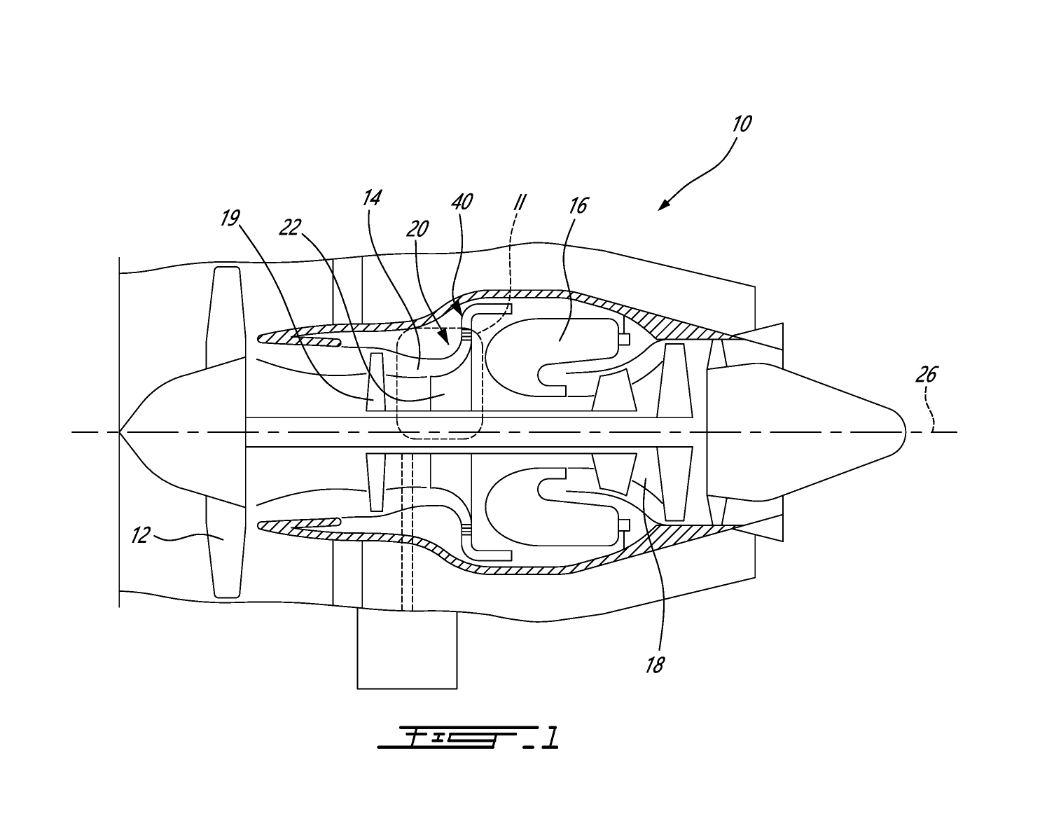

FIG. 1 illustrates an aircraft engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Although the aircraft engine 10 is a turbofan gas turbine engine 10, it should be understood that the present technology is also applicable to other types of aircraft engine having impellers. Of particular interest to the instant application, the compressor section 14 includes at least one centrifugal compressor 20, including generally an impeller 22 and a diffuser 40 downstream of the impeller 22.

In the depicted embodiment, the compressor section 14 includes an axial compressor 19, which may include one or more stage, each including stator vanes and rotor blades. In this embodiment, the axial compressor 19 acts as a low-pressure compressor of the aircraft engine 10. The compressor section 14 further includes a centrifugal compressor 20 located downstream of the axial compressor 19 relative to airflow through the compressor section 14 of the aircraft engine 10. In this embodiment, the centrifugal compressor 20 acts as a high-pressure compressor of the aircraft engine 10. The centrifugal compressor 20 includes an impeller 22 and a diffuser 40 located downstream of the impeller 22.

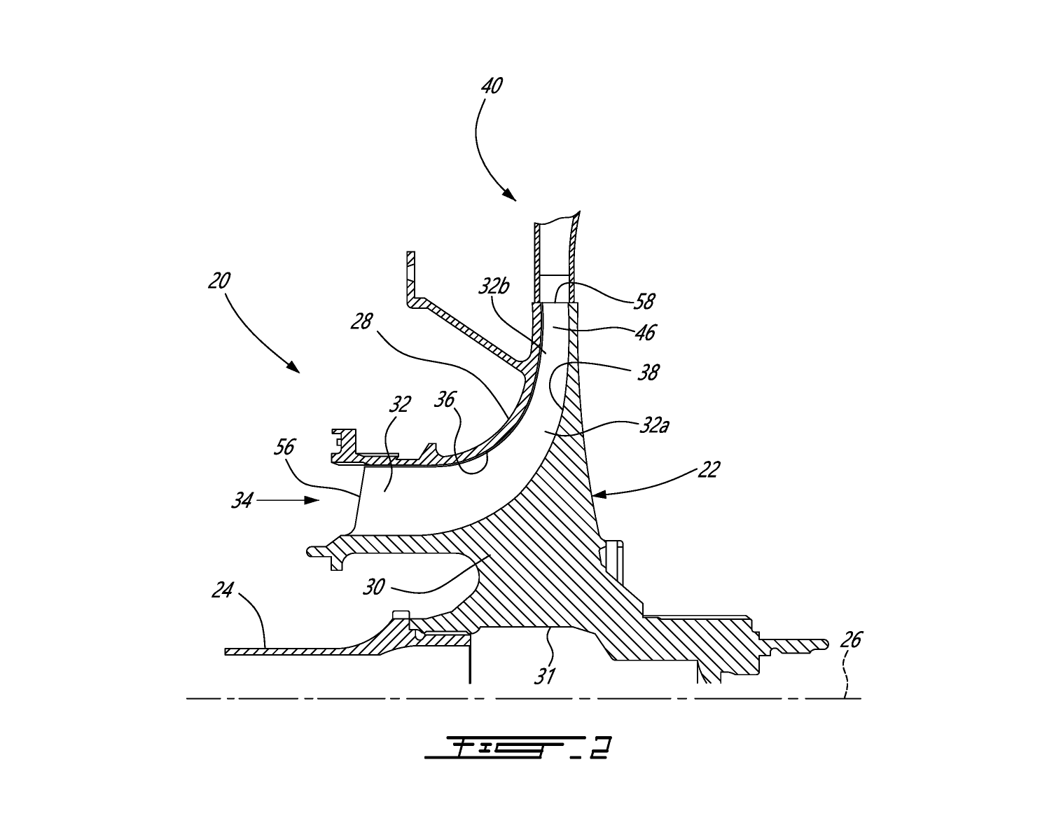

Referring to FIG. 2, the centrifugal compressor 20 includes impeller 22 fixed to a central shaft 24 and rotatable with the shaft 24 about a central axis 26 within a stationary impeller shroud 28 of the centrifugal compressor 20. The impeller 22 comprises a central hub 30 defining a bore 31 therethrough that is coaxial with the central axis 26. The impeller 22 also comprises a plurality of vanes 32 disposed around the hub 30, and extending radially outwardly thereof to define a radial periphery of the impeller 22. The vanes 32 may also be referred to as airfoils of the impeller 22. The vanes 32 and the surrounding shroud 28 are shaped to redirect an incoming axially-flowing fluid flow 34, radially outward by about ninety degrees, forcing the fluid flow 34 radially outwardly relative to the central axis 26, and increasing the velocity of the fluid flow 34. Although it is not essential, the hub 30 and the plurality of vanes 32 form in some embodiments a unitary piece, that is the impeller is monolithically formed. An annular fluid path is thus defined through the centrifugal compressor 20, along and through the vanes 32, between an inner surface 36 of the impeller shroud 28 and an outer surface 38 of the hub 30. Typically, although not necessarily, impellers are made of a monolithic body defining the hub 30 and the vanes 32 protruding from the hub.

Each vane 32 of the impeller 22 extends from a vane root 32a, located at the junction of the vane 32 and the outer surface 38 of the hub 30, to an outer free end 32b, that is spaced apart from the vane root 32a and is located inward of the inner surface 36 of the impeller shroud 28 to define a height of the vane at a given chord position. The vane 32 also has a leading edge 56 and a trailing edge 58. The leading and trailing edges 56, 58 extend from the vane root 32a to the free end 32b of the vane 32. The leading edge 56 forms an upstream end of the vane 32 where the incoming axially-flowing fluid flow 34 enters the impeller 22. The trailing edge 58 forms a upstream end of the vane 32 where airflow exits the impeller and enters the diffuser 40 immediately downstream therefrom. The diffuser 40 can be a vane type diffuser or may comprise a plurality of diffuser pipes. Alternate diffuser geometries are also possible.

In use, the incoming axially-flowing fluid flow 34 enters the impeller 22 at the inlet and thus first meets the leading edges 56 of the vanes 32. Therefore, the leading edges 56 of the impeller vanes 32 are most exposed to any grit, sand or other particulate debris that may be ingested into the aircraft engine 10 during operation. Over time, erosion of the leading edges 56 of the vanes 32 can thus occur.

The vanes 32, and in particular the leading edges 56 thereof, can have complex geometries which are selected to provide optimum aerodynamic performance. However, leading edges 56 having complex shapes also makes them more difficult to evaluate and/or measure for the purposes of determining whether excessive erosion has occurred.

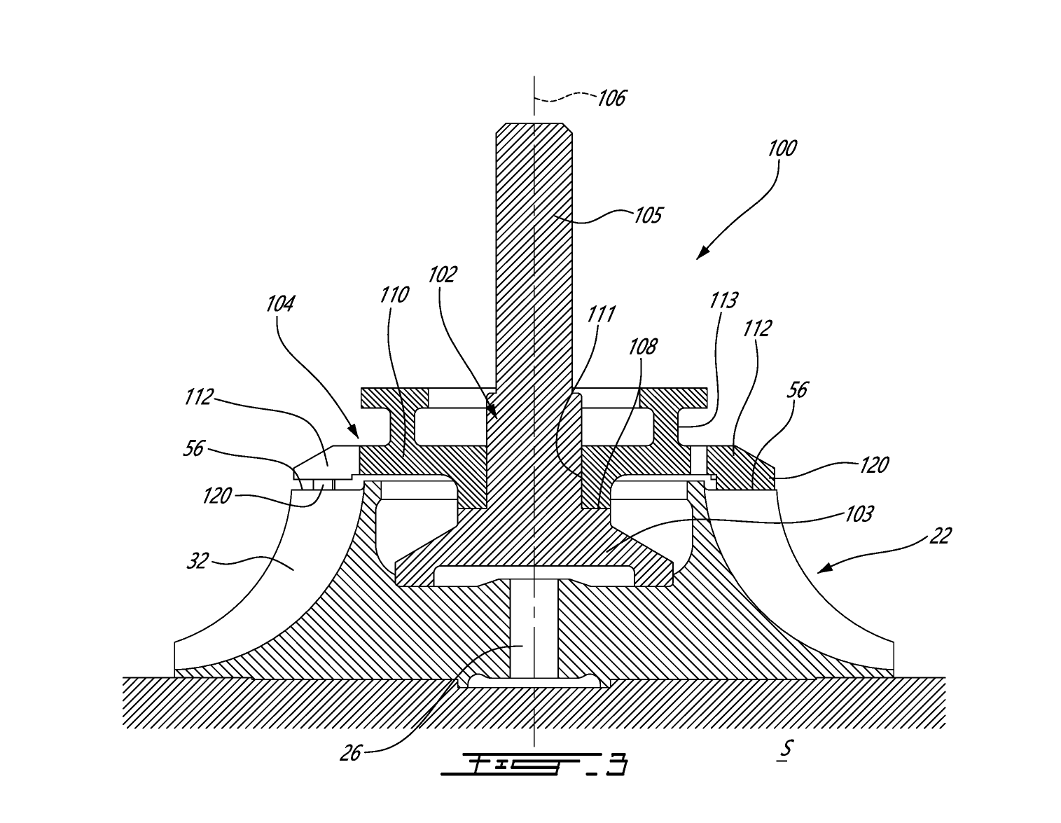

Referring now to FIGS. 3-5, a validation tool 100 which will now be described in further detail. The validation tool 100 (which may also be referred to herein simply as the “tool”) is a compliance verification tool for validating conformity of leading edges of an impeller, and which is therefore used to determine whether the an impeller, such as the impeller 22 described above, is compliant with a geometric specification or standard. More particularly, the validation tool 100 is used to validate whether or not the leading edges 56 of the impeller 22 confirm to a required geometric specification. As noted above, erosion of the leading edges 56 can occur over time, and therefore the present validation tool 100 is used to determine validate whether or not the leading edges 56 of the impeller 22 still comply with their original specification values. Of note, the validation tool 100 does not measure per se a surface of the leading edge. Accordingly, the validation tool 100 is not able to measure, for example, a specific surface value (e.g., a curvature or length of a surface). Instead, the validation tool 100 acts as a “Go – No Go” type gauge, which allows the user to determine if, yes or no, the leading edges remain compliant with their original spec. The present validation tool may thus be referred to as a compliance verification tool, or an inspect tool, but it is not a measurement tool which measures actual values of a surface.

Referring particularly to FIG. 3, the validation tool 100 is shown mounted to a impeller 22, which has been removed from the aircraft engine 10 for evaluation purposes. The validation tool 100 includes a support 102 to which is mounted a probe element 104. The support 102 includes a base 103 and a spindle 105 that extends outwardly away from the base 103. The base 103 of the support 102 is configured to be received on, e.g. abutted to, a reference surface 60 on a front face of the impeller 22, such that the base 103 can be abutted against the reference surface 60. In the depicted embodiment, the impeller 22 has been placed rear side down on a horizontal supporting substrate S, such that the leading edges 56 of the impeller are facing upwardly and exposed for testing purposes. Accordingly, when the support 102 is mounted on the impeller 22 in the manner shown in FIG. 3, the spindle 105 of the support 102 extends substantially vertically upward, away from the base 103, and defines a spindle axis 106 that is coaxial with the central axis 26 of the impeller 22.

The probe element 104 of the validation tool 100 is rotatably mounted on the support 102, in such a manner that the probe element 104 can rotate about the spindle axis 106 defined by the spindle 105 of the support 102. In the depicted embodiment, the probe element 104 rests on an upper annular flange 108 of the base 103 and is thus supported thereby during rotation of the probe element 104 relative to the base 103 and the spindle 105. Alternately, however, the probe element 104 may be supported elsewhere on the support 102, providing that the probe element 104 remains rotatably about the spindle axis 106.

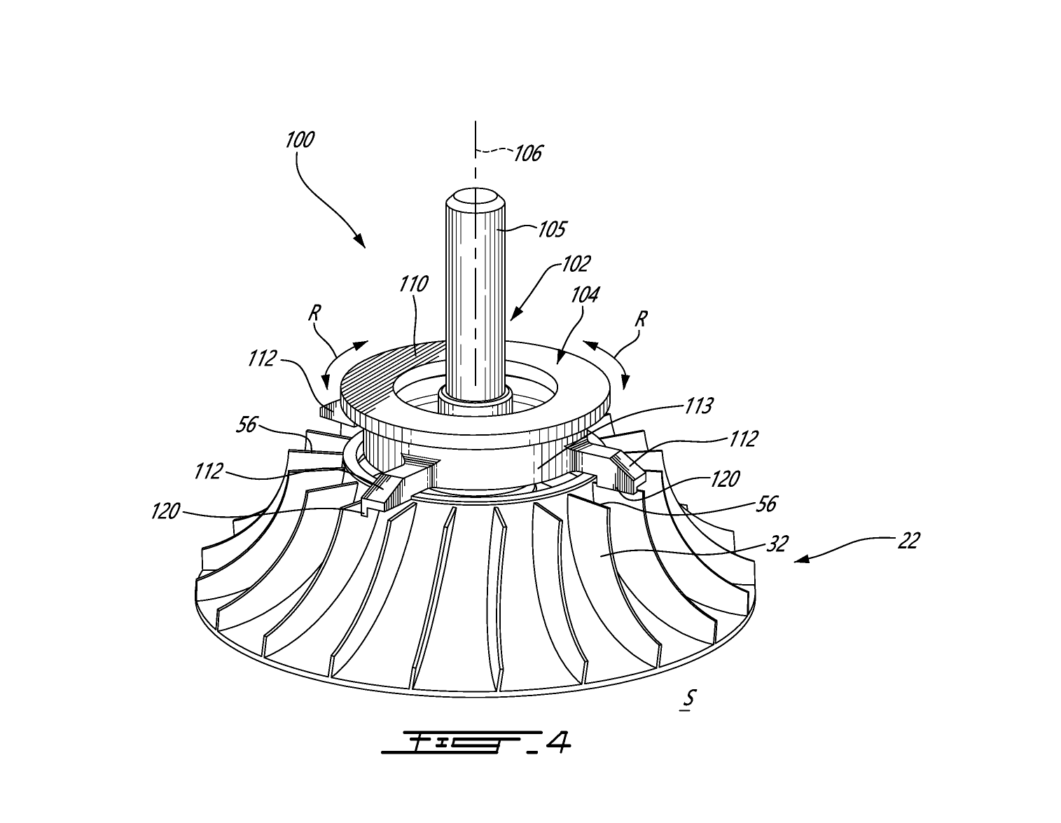

Referring now to FIGS. 3 and 4, the probe element 104 will now be described in more detail. The probe element 104 includes an annular body 110 which defines a central bore 111 therein for mating receiving the spindle 105 of the support 102 therethrough. At a radial outer edge 113 of the annular body 110 is located one or more fingers 112 that extend radially outwardly away from the annular body 110 of the probe element 104. The fingers 112 are fixed on the annular body 110 at a given circumferential position thereon. As seen in FIG. 3, these outwardly extending fingers 112 may extend radially a distance sufficient to substantially cover a diameter of the inlet of the impeller 22 to be validated. Accordingly, as best seen in FIG. 4 for example, the fingers 112 extend radially outwardly to overly the leading edges 56 of the impeller 22.

Each of the one or more fingers 112 has a conformal probe 120 located on an underside thereof, namely on a side of the finger 112 that faces towards the leading edges 56 of the impeller 22 when the validation tool 100 is mounted thereto as shown in FIG. 3. The conformal probe 120 extends axially toward the base of the support, away from the finger 112 and toward the leading edges 56 of the impeller 22. The conformal probe 120 has a probe tip with a bottom surface that faces towards the leading edges, and which, in a particular embodiment, is shaped and sized to be complimentary to the leading edges of the impeller. In a particular, embodiment, the conformal probe 120 is integrally formed with the finger 112. In an alternate embodiment, however the conformal probe 120 may be removably mounted to the finger 112. Whether the conformal probes 120 are integrally formed with the remainder of the probe element 104 or not, they are constructed from a durable and precision-engineered material capable of maintaining its shape accuracy.

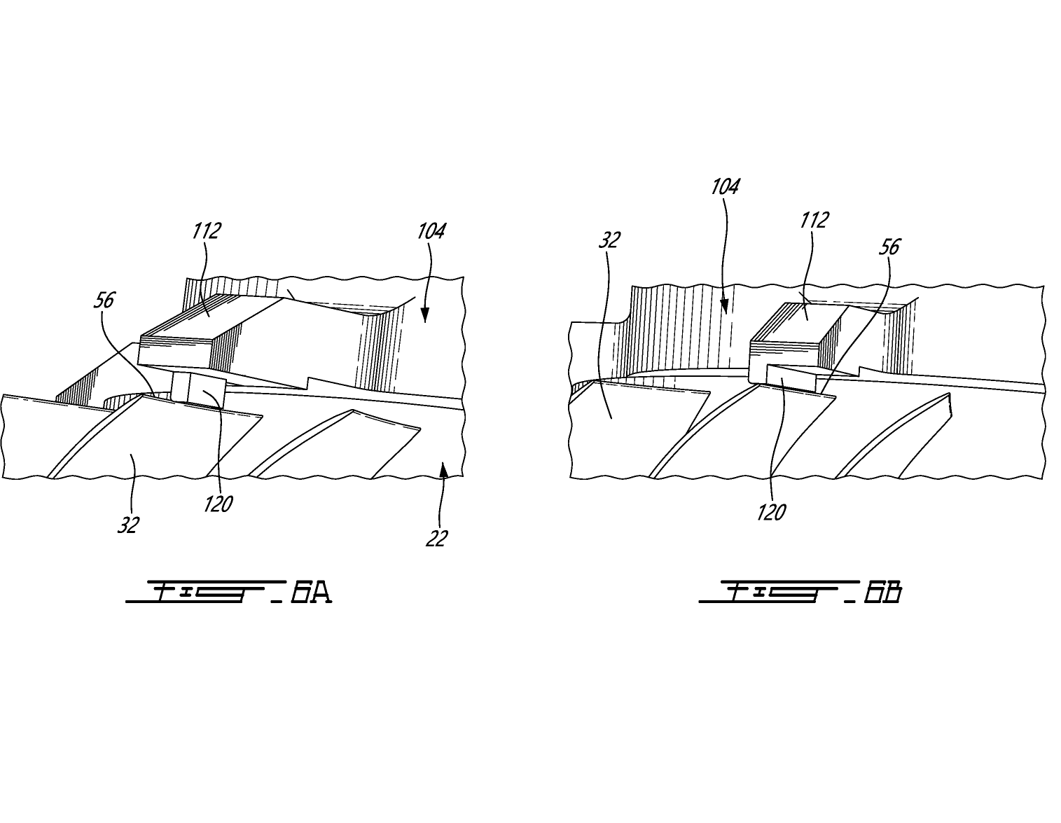

In all cases, however, the conformal probe is not displaceable in a span-wise direction along the length of a leading edge 56. Each conformal probe cannot be radially displaced relative to the spindle axis 106 and thus maintains a fixed radial position away from the spindle axis 106 during operation of the validation tool 100. More particularly, each conformal probe 120 is located at a selected radial position and thus serves to validate whether or not the leading edges 56 of the impeller 22 are compliant with a predetermined specification at that particular radial position of the leading edges 56. For example, a conformal probe 120 can be positioned on a finger 112 such that it is located at a mid-span point relative to the underlying leading edges 56 (as depicted in FIG. 6A, for example), in which case this conformable probe 120 is able to validate whether or not this mid-span point on the leading edge 56 complies with the specifications for that specific radial location on the leading edge 56. This is done by rotating the probe element 104 about the spindle axis 106, thereby passing the conformal probe 120 over one or more of the leading edges 56 at its given span-wise location. Another conformal probe 120, located on a different finger 112, can be located along a radially outer length of the leading edges 56 (as shown in FIG. 6B, for example), in which case this conformal probe 120 is used to validate whether or not the radially outer portion of the leading edges 56 confirms to the specifications for this portion of the leading edges 56.

In the embodiment of FIG. 6A, the conformal probe 120 has a radial length in a radial direction relative to the spindle axis 106 that is less than a full-span length of the leading edge 56 from hub to tip of the vane 32. Further, in the embodiment of FIG. 6A, the conformal probe 120 straddles the mid-span point of the leading edge 56.

In the embodiment of FIG. 6B, the conformal probe 120 has a greater radial length (i.e., a length in the radial direction relative to the spindle axis 106). More particularly, the conformal probe 120 in this embodiment has a radial length that covers at least a majority (i.e., more than 50%) of the total span-wise length of the leading edge 56. This includes, in the depicted embodiment, at least the radially outer half of the leading edge 56. In the embodiment shown in FIG. 6B, the conformal probe 120 has a radial length that is substantially equal to (i.e. is equal to, ± 10%) the total span-wise length of the leading edge 56.

Further, in the embodiments of both FIG. 6A and 6B, the conformal probe 120 extends downwardly from the finger 112 of the probe element 104 and is located only on one circumferential side of the finger 112 (e.g., the left-hand side of the finger, when viewed as shown in FIGS. 6A-6B). In these embodiments, the circumferential thickness of the finger is greater than that of the conformal probe 120. Stated differently, the conformal probe 120 has a circumferential thickness that is less than that of the finger 112. Even more specifically, the circumferential thickness of the conformal probe 120 is less than half of the circumferential thickness of the finger 112 (and may even be one quarter or less).

The term “validating” as used herein, in the context of validating conformity of a leading edge with a predetermined specification of the leading edge, is understood to mean determining whether the leading edges conform to or are in compliance with a specification of the leading edges. This determining is done by verifying if an axial gap exists, or not, between the leading edges 56 and the conformal probe(s) 56 of the validation tool. Thus, in a particular embodiment, this includes determining if an actual distance D corresponds to a specification value for this distance (i.e., when the vanes are new or not eroded). The distance D is measured, as shown in FIG. 3, in a direction parallel to the spindle axis 106, between the reference surface 60 of the impeller 22 (or alternately another selected reference surface on the impeller, such as the back face thereof for example) and the leading edges 56 of the vanes 32. If one or more of the leading edges 56 have eroded as a result of wear caused over time by operation of the engine, then the actual distance D will be less than the specification value of this measurement. The specification value may, for example, correspond to the distance D when measured on a newly manufactured impeller 22 (i.e., before any use of the impeller within the engine).

Accordingly, when the probe element 104 is rotated about the spindle axis 106, the conformal probe or probes 120 on the probe element 104 will pass over one or more of the leading edges 56. If an axial gap, measured in a direction parallel to the spindle axis 106, between the conformal probe 120 and the leading edge 56 at this location, is observed by the operator or otherwise determined (in which case distance D is smaller than the specification value for this measurement), this indicates that the leading edge 56 has worn or eroded away, or recessed downstream, at this location. Alternately, if the conformal probe 120 were to contact the leading edge 56 when the probe element 104 is rotated about the spindle axis 106, caused for example because the leading edge or leading edges 56 are projecting upstream more than they should (in which case distance D is greater than the specification value for this measurement), which may have occurred due to deflection, foreign object damage or other. In both cases, non-compliance with the specifications of the leading edges is determined. If, on the other hand, the conformal probe 120 of the probe element 104 can pass over the leading edges 56 when the probe element 104 is rotated, and little to no axial gap is determined to exist between the leading edges 56 and the bottom surface of the conformal probe 120, then the leading edges 56 are determined to be compliant with the specifications and thus deemed acceptable for further use in the engine. By “little to no” axial gap, as used in this context, it is to be understood that the bottom surface of the conformal probe 120 will just barely clear the leading edges 56 (i.e., a “clearance fit” exists between the conformal probe 120 and the leading edges 56) without coming into contact with each other. Thus, in this manner the presence of a clearance fit is detected. This detection may be done via a visual inspection conducted by the user of the validation tool, or may include using a detection system (including, for example, a camera or laser and corresponding image processing). The tolerance between the leading edges 56 and the conformal probe 120 may also be defined as being a close running or sliding clearance fit, when the leading edges 56 are in compliance with their spatial specifications.

The conformal probes 120 are provided with a predetermined shape or shapes, which mimic different leading edge shapes and positions, and enable a comprehensive erosion assessment across each vane or airfoil. The conformal probes 120 can, in certain embodiments, have a continuous profile which mimics, or is complimentary to, the complete leading edge shape or several sections or points which can locally probe corresponding local areas on the leading edges 56 of the impeller vanes 32.

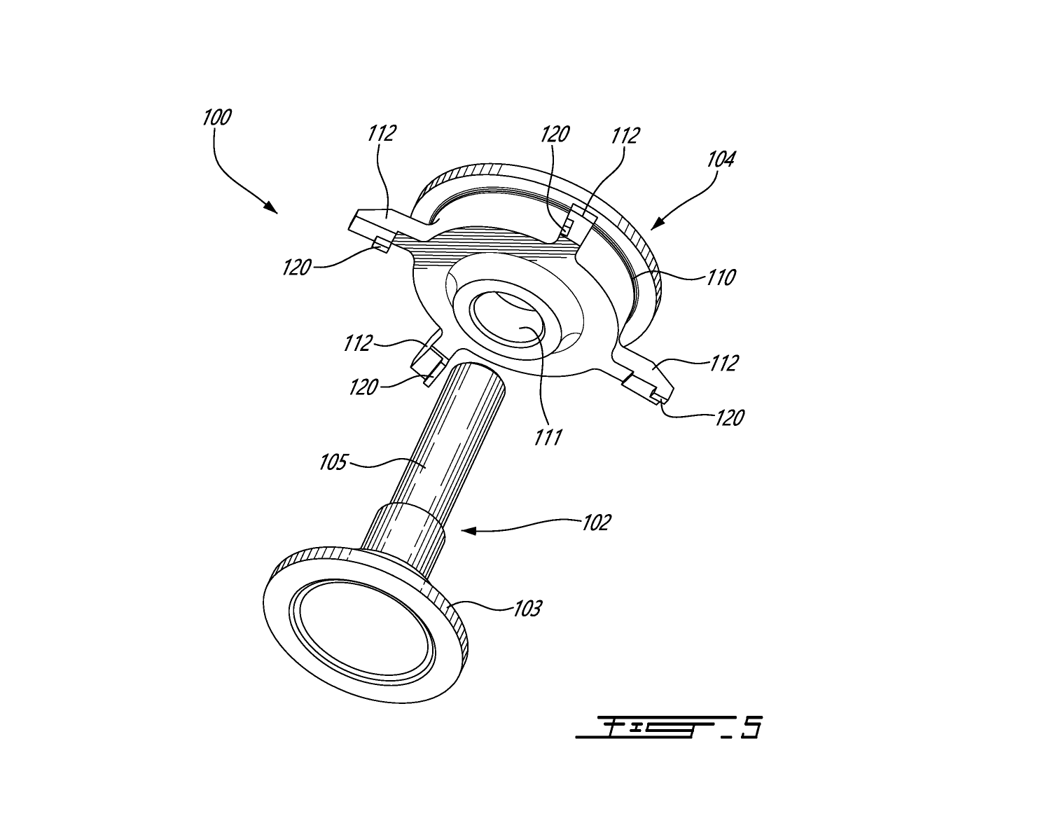

In the embodiment depicted, the probe element 104 of the validation tool 100 includes four projecting fingers 112 (see FIG. 5, for example), each having a conformal probe 120 thereon. However, it is to be understood that the probe element 104 can include any number of fingers 112 (from only a single finger 112 to more than four) each having a conformal probe 120 thereon. Additionally, in the depicted embodiment, each of the four fingers 112 of the probe element 104 is provided with a different conformal probe 120 thereon, wherein each conformal probe 120 can be used to validate a different radial location on the leading edges 56 and/or a different geometric feature of the leading edges 56. For example, one of the conformal probes 120 may be located to validate a radially innermost portion of the leading edges 56 whereas another conformal probe 120 may be located to validate a radially outermost portion of the leading edges 56. Each of the conformal probes 120 is therefore selected to validate a different parameter of the leading edge (e.g., nominal position, minimum material condition, maximum material condition, etc.).

Because the probe element 104 rotates on the support 102, as described above, by rotating the probe element 104 as shown at R in FIG. 4, the radially extending fingers 112 rotate with the probe element 104 which in turn causes the conformal probe(s) 120 to pass over the same point on the leading edges 56 of a plurality of vanes 32. This circular sweeping action of the conformal probe(s) 120 enables multiple vanes 32 to be tested in rapid succession, without needing to reposition or recalibrate the tooling in any way. In other words, rotating the probe element 104 (whether by hand or via a motorized mechanism) will case each of the conformal probes 120 to sweep over a plurality of leading edges 56 very quickly. The present validation tool 100 thus enables a rapid and simple process for validating that the vane leading edges of the impeller 22 being tested conform to the required specifications. Any vanes and leading edges not confirming to the required specifications are therefore easily and rapidly identified. Operators of the validation tool 100 thus receive immediate feedback on erosion conditions of the vanes and/or their conformity to acceptable specifications.

The validation tool 100 accordingly provides a convenient, accurate and readily repeatable way of evaluating conformity of impeller vane leading edges with required standards and/or specifications. Impellers can thus be easily assessed for any erosion of the vane leading edges, enabling optimal impeller performance evaluation and permitting well-informed maintenance decisions for impellers 22 of aircraft engines 10.

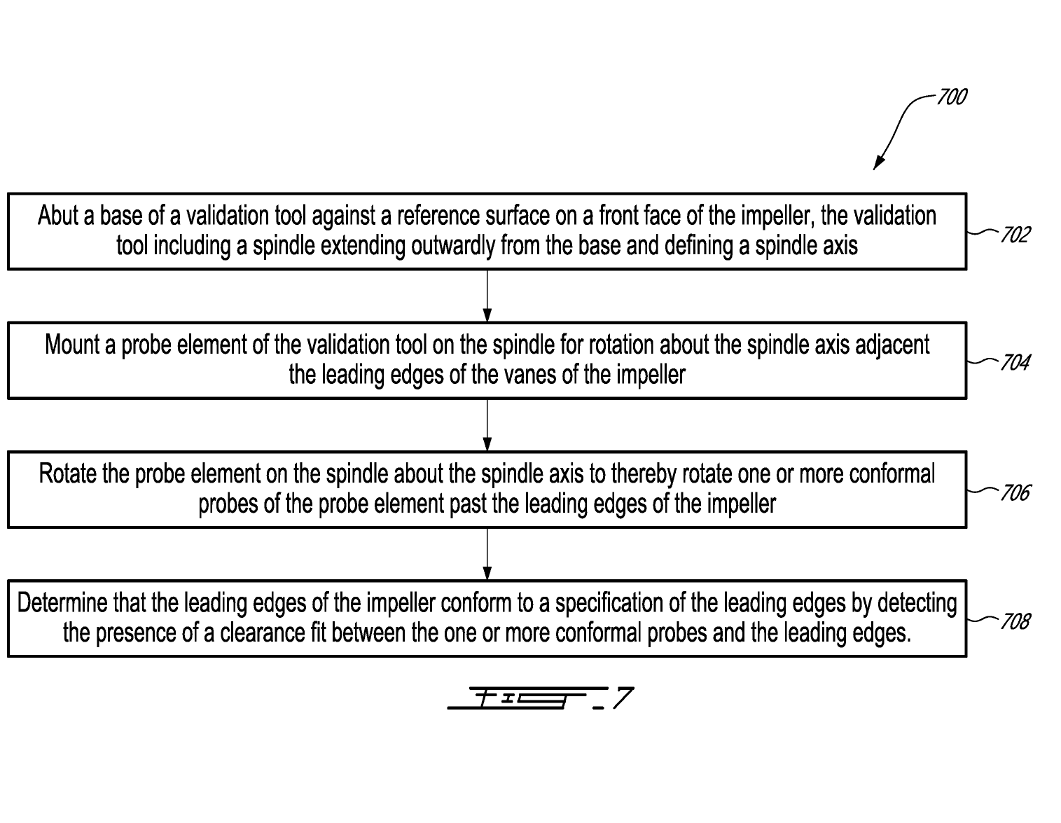

Having described the validation tool 100 above, and referring now to FIG. 7, a method 700 for determining conformity of leading edges of vanes on an impeller will now be described.

At step 702, a base of a validation tool is abutted against a reference surface on a front face of the impeller. The validation tool includes a spindle extending outwardly from the base and defining a spindle axis.

At step 704, a probe element of the validation tool is mounted on the spindle for rotation about the spindle axis adjacent the leading edges of the vanes of the impeller.

At step 706, the probe element is rotated on the spindle about the spindle axis to thereby rotate one or more conformal probes of the probe element past the leading edges of the impeller.

Then, at step 708, the method includes determining that the leading edges of the impeller conform to a specification of the leading edges by detecting the presence of a clearance fit between the one or more conformal probes and the leading edges.

In one embodiment, the method 700 also includes determining that the leading edges of the impeller are non-conforming with the specification by detecting the presence of an axial gap between the one or more conformal probes and the leading edges when the probe element is rotated on the spindle about the spindle axis.

In one embodiment, each of the one or more conformal probes of the probe element is located at a fixed radial distance away from the spindle axis, the fixed radial distance corresponding to a common span-wise position on each of the leading edges. The method 700 accordingly also includes, in this embodiment, using the one or more conformal probes to determine that the common span-wise position on each of the leading edges conforms to the specification.

In one embodiment, the probe element includes multiple of the conformal probes. The method 700 accordingly also includes, in this embodiment, using each of the multiple conformal probes to validate a different parameter of the leading edges of the impeller.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The terms “connected”, “mounted” or "coupled to" may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, a similar impeller having two bodies may be used in a turbine section of an aircraft engine. Yet further modifications could be implemented by a person of ordinary skill in the art in view of the present disclosure, which modifications would be within the scope of the present technology.

1. A validation tool for determining conformity of leading edges of vanes on an impeller of an aircraft engine, the validation tool comprising:
a support including a base and a spindle extending away from the base, the base being configured to be received on a reference surface of the impeller and the spindle defining a spindle axis; and
a probe element rotatably mounted on the support, the probe element including an annular body defining a central bore matingly receiving the spindle of the support therein, the probe element being rotatable about the spindle axis and including a conformal probe thereon extending axially toward the base of the support and configured to have a clearance fit with multiple of the leading edges at a same span-wise position of each when the probe element is rotated on the spindle of the support.

2. The validation tool as defined in claim 1, wherein the conformal probe is located at a fixed radial position relative to the spindle axis.

3. The validation tool as defined in claim 1, wherein the conformal probe has a probe tip that is shaped and sized to be complimentary to the leading edges of the impeller.

4. The validation tool as defined in claim 1, wherein the probe element includes one or more fingers extending radially outward from the annular body, each of the one or more fingers having the conformal probe thereon.

5. The validation tool as defined in claim 4, wherein the one or more fingers are fixed on the annular body at circumferentially spaced-apart positions thereon.

6. The validation tool as defined in claim 4, wherein the one or more fingers and the conformal probe thereon are integrally formed with the annular body of the probe element.

7. The validation tool as defined in claim 4, wherein the conformal probe on each of the one or more fingers is different.

8. The validation tool as defined in claim 1, wherein the conformal probe has a radial length in a direction radial to the spindle axis that is configured to be less than a full-span length of the leading edge from a hub to a tip of the vanes.

9. The validation tool as defined in claim 8, wherein the conformal probe is positioned to radially straddle a mid-span point of the leading edge between the hub to the tip of the vanes.

10. The validation tool as defined in claim 1, wherein the conformal probe has a radial length in a direction that is radial to the spindle axis that covers more than 50% of a full-span length of the leading edge.

11. The validation tool as defined in claim 10, wherein the conformal probe is configured to extend along at least a radially outer half of the leading edge.

12. The validation tool as defined in claim 10, wherein the radial length of the conformal probe is substantially equal to the full-span length of the leading edge.

13. The validation tool as defined in claim 4, wherein the conformal probe is located only on one circumferential side of the one or more fingers.

14. The validation tool as defined in claim 13, wherein the conformal probe has a circumferential thickness that is smaller than that of the one or more fingers.

15. The validation tool as defined in claim 14, wherein the circumferential thickness of the conformal probe is less than half of the circumferential thickness of the one or more fingers.

16. The validation tool as defined in claim 1, further comprising a detection system operable for determining that the leading edges of the impeller conform to a specification by detecting the presence of the clearance fit between the conformal probe and the leading edges.

17. A method for determining conformity of leading edges of vanes on an impeller of an aircraft engine, the method comprising:
abutting a base of a validation tool against a reference surface on a front face of the impeller, the validation tool including a spindle extending outwardly from the base and defining a spindle axis;
mounting a probe element of the validation tool on the spindle for rotation about the spindle axis adjacent the leading edges of the vanes of the impeller;
rotating the probe element on the spindle about the spindle axis to thereby rotate one or more conformal probes of the probe element past the leading edges of the impeller; and
determining that the leading edges of the impeller conform to a specification of the leading edges by detecting the presence of a clearance fit between the one or more conformal probes and the leading edges.

18. The method as defined in claim 17, further comprising determining that the leading edges of the impeller are non-conforming with the specification by detecting the presence of an axial gap between the one or more conformal probes and the leading edges when the probe element is rotated on the spindle about the spindle axis.

19. The method as defined in claim 17, wherein each of the one or more conformal probes of the probe element is located at a fixed radial distance away from the spindle axis, the fixed radial distance corresponding to a common span-wise position on each of the leading edges, and using the one or more conformal probes to determine that the common span-wise position on each of the leading edges conforms to the specification.

20. The method as defined in claim 17, wherein the probe element includes multiple of the one or more conformal probes, the method further including using each of the multiple conformal probes to validate a different parameter of the leading edges of the impeller.
